(19) United States
(12) Patent Application Publication
(10) Pub. No.: US 2024/0391546 A1
(43) Pub. Date: Nov. 28, 2024

(54) BATTERY MOUNTING SYSTEM

(71) Applicants: HYUNDAI MOTOR COMPANY, Seoul (KR); KIA CORPORATION, Seoul (KR)

(72) Inventors: Suwhan Kim, Busan (KR); Haejung Kang, Busan (KR); Sangok Byun, Busan (KR); Jeong Hwan Ha, Gyeongju-si (KR); Yongcheol Jeong, Ulsan (KR)

(73) Assignees: HYUNDAI MOTOR COMPANY, Seoul (KR); KIA CORPORATION, Seoul (KR)

(21) Appl. No.: 18/381,063

(22) Filed: Oct. 17, 2023

(30) Foreign Application Priority Data
May 22, 2023 (KR) 10-2023-0065526

(51) Int. Cl. B62D 65/02

(52) U.S. Cl. CPC B62D 65/024

(57) ABSTRACT

A battery mounting system is configured to mount a battery pack assembly loaded on a skid cart to a lower portion of a vehicle body. The system includes a lifting unit including a lift plate configured to move up and down direction and installed on a base frame. The system includes a floating unit including a shift plate coupled to the skid cart. The floating unit is installed on the lift plate so that the shift plate moves in accordance with a position of the vehicle body. The system includes a tool assembly installed on both sides of the shift plate in a vehicle width direction to fasten the vehicle body and the battery pack assembly.

### CROSS-REFERENCE TO RELATED APPLICATION

This application claims priority to and the benefit of Korean Patent Application No. 10-2023-0065526 filed in the Korean Intellectual Property Office on May 22, 2023, the entire contents of which are incorporated herein by reference.

### BACKGROUND

### (a) Field of the Disclosure

An embodiment of the present disclosure relates to a battery mounting system, and more particularly, to a battery mounting system configured to mount a high-voltage battery pack assembly on a lower portion of a vehicle body.

### (b) Description of the Related Art

Recently, electric vehicles have been steadily developed in consideration of environment pollution and development of alternative energy.

An electric vehicle includes a driving motor and a high-voltage battery pack assembly. A battery pack assembly is an energy source for driving the driving motor and may supply high voltage power to the driving motor through an inverter.

Here, the battery pack assembly is typically mounted on a lower portion of a vehicle body, for example, on a floor structure of an under body.

Such a battery pack assembly includes a battery pack case and at least one battery module assembly mounted on the battery pack case.

Since the battery pack assembly has a considerably large volume and weight, a strong fastening force is required to mount the battery pack assembly on the vehicle body.

Furthermore, since ease of assembly of the vehicle body is also an important issue for the battery pack assembly, the pertinent industry is focusing on research and development of a battery mounting system for assembling a vehicle body including a battery pack assembly.

The subject matter described in the Background section is provided to enhance understanding of the background of the disclosure. Therefore, the Background section may include subject matter that is not already known to those of ordinary skill in the art to which this technology pertains.

### SUMMARY

The present disclosure provides a battery mounting system capable of reducing the investment cost of manufacturing facilities, improving the operability of manufacturing facilities, and ensuring the degree, safety, and robustness of mounting a battery pack assembly to a vehicle body.

A battery mounting system according to an embodiment of the present disclosure is configured to mount a battery pack assembly loaded on a skid cart on a lower portion of a vehicle body. The battery mounting system includes i) a lifting unit including a lift plate configured to move up and down, the lifting unit installed on a base frame, ii) a floating unit including a shift plate coupled to the skid cart with the floating unit installed on the lift plate so that the shift plate moves in accordance with a position of the vehicle body, and iii) a tool assembly installed on both sides of the shift plate in a vehicle width direction to fasten the vehicle body and the battery pack assembly.

In the battery mounting system according to an embodiment of the present disclosure, the lifting unit may include one servo motor fixed to the base frame and at least two chain winding units operatively connected to the one servo motor. One of the at least two chain winding units is provided on each side of the one servo motor in a vehicle body front and rear direction. The system also includes at least two push-pull chains. One of the at least two push-pull chains is respectively connected to each of the chain winding units so as to travel in the up and down direction. The system also includes at least two lift frames. One of the at least two lift frames is respectively coupled to each side of the lift plate in the vehicle body front and rear direction and connected to the push-pull chains.

In the battery mounting system according to an embodiment of the present disclosure, the lifting unit may further include at least two safety cylinders coupled to mounting frames that are coupled to the base frame in the up and down direction. One of the at least two safety cylinders is respectively connected to each of the lift frames. The lifting unit also includes at least two guide shafts. One of the at least two guide shafts is respectively mounted on each of the mounting frames to be movable in the up and down direction and is respectively coupled to each side of the lift plate.

In the battery mounting system according to an embodiment of the present disclosure, the floating unit may include a first floating assembly installed on the lift plate so as to rotate the shift plate and a second floating assembly installed on the first floating assembly so as to move the shift plate in the vehicle body front and rear direction and the vehicle width direction. The second floating assembly may be coupled to the shift plate.

In the battery mounting system according to an embodiment of the present disclosure, the first floating assembly may include: an arc guide rail coupled to both sides of an upper surface of the lift plate in the vehicle body front and rear direction; at least one first slider slidably coupled to the arc guide rail; and a first floating plate coupled to the at least one first slider in the vehicle width direction.

In the battery mounting system according to an embodiment of the present disclosure, the second floating assembly may include: at least one first straight guide rail coupled to an upper surface of the first floating plate in the vehicle width direction; a second slider slidably coupled to the at least one first straight guide rail; a second floating plate coupled to the second slider in the vehicle body front and rear direction; a second straight guide rail coupled to an upper surface of the second floating plate in the vehicle body front and rear direction; and a third slider slidably coupled to the second straight guide rail and coupled to a lower portion of the shift plate.

The battery mounting system according to an embodiment of the present disclosure may further include at least two first centering units configured to push the vehicle body in the vehicle width direction. One of the at least two centering units is respectively installed on each side of the shift plate in the vehicle width direction so as to adjust centering of the shift plate through the floating unit. The system also may include a second centering unit configured to pull and or push the vehicle body in the vehicle body front and rear direction. The second centering unit is installed on one side of the shift plate in the vehicle body front and rear direction so as to adjust centering of the shift plate through the floating unit.

In the battery mounting system according to an embodiment of the present disclosure, the first centering unit may include at least two mounting plates. One of the at least two mounting plates is respectively fixed to each side of a lower portion of the shift plate in the vehicle width direction. The first centering unit may also include: at least one fixing block coupled to each of at least two the mounting plates in the vehicle width direction; a push guide rail coupled to the at least one fixing block in the vehicle width direction; a moving block coupled to the push guide rail to be slidably movable; a first push cylinder coupled to the at least one fixing block in the vehicle width direction; a second push cylinder connected to the moving block in the vehicle width direction and connected to the first push cylinder in the vehicle width direction; and a push block installed on the moving block to be movable in the up and down direction.

In the battery mounting system according to an embodiment of the present disclosure, the first centering unit may further include a guide plate coupled to the moving block so as to support a lower portion of the second push cylinder and an up-down cylinder coupled to the moving block in the up and down direction and connected to the push block.

In the battery mounting system according to an embodiment of the present disclosure, the second centering unit may include a gripper cylinder installed on the shift plate to be movable in the vehicle body front and rear direction and the up and down direction and may include a pair of pull-push grippers installed on the gripper cylinder to be movable in a direction away from or closer to each other.

In the battery mounting system according to an embodiment of the present disclosure, the second centering unit may include: a fixed bracket fixed to the shift plate; a first moving bracket coupled to the fixed bracket to be movable in the up and down direction; a second moving bracket coupled to the first moving bracket to be movable in the up and down direction, and to which the gripper cylinder is coupled to be movable in the vehicle body front and rear direction; a main vertical cylinder coupled to the fixing bracket in the up and down direction and connected to the first moving bracket; a sub vertical cylinder coupled to the first moving bracket in the up and down direction and connected to the second moving bracket; and a horizontal cylinder coupled to the second moving bracket in the vehicle body front and rear direction, and connected to the gripper cylinder.

The battery mounting system according to an embodiment of the present disclosure may further include: at least one first clamper installed on an upper surface of the lift plate so as to clamp the shift plate in the vehicle body front and rear direction; and at least one second clamper installed on the upper surface of the lift plate so as to clamp the shift plate in the vehicle width direction.

In the battery mounting system according to an embodiment of the present disclosure, the at least one first clamper may include a first clamping cylinder coupled to the upper surface of the lift plate in the vehicle body front and rear direction and a pair of first clamping rollers connected to the first clamping cylinder so as to clamp a first dog block connected to the shift plate.

In the battery mounting system according to an embodiment of the present disclosure, the at least one second clamper may include a second clamping cylinder coupled to the upper surface of the lift plate in the vehicle width direction and a pair of second clamping rollers connected to the second clamping cylinder so as to clamp a second dog block connected to the shift plate.

In the battery mounting system according to an embodiment of the present disclosure, the tool assembly may include at least two slide plates. One of the at least two slide plates is respectively coupled to each side of the shift plate in the vehicle width direction to be slidably movable in the vehicle width direction. The tool assembly may also include a plurality of nut runners installed on the at least two slide plates in the vehicle body front and rear direction and provided to be movable in the up and down direction. The tool assembly may also include at least one master pin installed on the at least two slide plates to be movable in the up and down direction so as to be inserted into a master hole formed in the battery pack assembly in the up and down direction.

In the battery mounting system according to an embodiment of the present disclosure, a pair of nut runners among the plurality of nut runners may be respectively coupled to the at least two slide plates to be movable in the vehicle body front and rear direction.

In the battery mounting system according to an embodiment of the present disclosure, the tool assembly may include at least one mounting block fixed to each of the at least two mounting plates. One of the at least two mounting plates is respectively coupled to each side of a lower portion of the shift plate in the vehicle width direction. The tool assembly may also include a first position adjusting unit installed on the at least one mounting block so as to adjust positions of the at least two slide plates in the vehicle width direction. The tool assembly may also include a second position adjusting unit installed on the at least two slide plates so as to adjust positions of the pair of nut runners in the vehicle body front and rear direction.

In the battery mounting system according to an embodiment of the present disclosure, the first position adjusting unit may include a first position adjusting cylinder coupled to the at least one mounting block in the vehicle width direction and may include a second position adjusting cylinder connected to the first position adjusting cylinder in the vehicle width direction and connected to the slide plates in the vehicle width direction.

In the battery mounting system according to an embodiment of the present disclosure, the second position adjusting unit may include a third position adjusting cylinder coupled to the slide plates in the vehicle body front and rear direction and connected to one of the pair of nut runners and may include a fourth position adjusting cylinder coupled to the slide plates in the vehicle body front and rear direction and connected to the other of the pair of nut runners.

The battery mounting system according to an embodiment of the present disclosure may further include: a plurality of driving wheels and a plurality of idle wheels installed on both edges of the shift plate in the vehicle body front and rear direction so as to move the skid cart in the vehicle body front and rear direction; at least one cart clamper installed on the shift plate so as to clamp the skid cart; and at least one tooling pin installed on the shift plate to be movable in the up and down direction so as to align the skid cart on the shift plate.

The embodiments of the present disclosure may reduce the investment cost of manufacturing facilities, improve control and operability of manufacturing facilities, prevent the risk of a lifter falling, and ensure the degree and robustness of mounting of the battery pack assembly to the vehicle body. This may reduce error in mounting the battery pack assembly to the vehicle body.

In addition, the effects obtainable or predicted by the embodiments of the present disclosure are disclosed directly or implicitly in the detailed description of the embodiments of the present disclosure. In other words, various effects predicted according to embodiments of the present disclosure are disclosed in the detailed description below.

### BRIEF DESCRIPTION OF THE DRAWINGS

Because the drawings included herein are provided only for reference in explaining the embodiments of the present disclosure, the technical idea of the present disclosure should not be construed as being limited to the accompanying drawings.

FIG. 1 is a block diagram schematically illustrating a battery mounting system according to an embodiment of the present disclosure.

FIG. 2 is a perspective view illustrating a battery mounting system according to an embodiment of the present disclosure.

FIG. 3 is an exploded perspective view illustrating a battery mounting system according to an embodiment of the present disclosure.

FIG. 4 is a side view illustrating a battery mounting system according to an embodiment of the present disclosure.

FIGS. 5 and 6 are perspective views illustrating a lifting unit applied to a battery mounting system according to an embodiment of the present disclosure.

FIGS. 7 and 8 are side views illustrating a lifting unit applied to a battery mounting system according to an embodiment of the present disclosure.

FIGS. 9 and 10 are diagrams illustrating a safety cylinder of a lifting unit applied to a battery mounting system according to an embodiment of the present disclosure.

FIGS. 11 and 12 are perspective views illustrating a floating unit applied to a battery mounting system according to an embodiment of the present disclosure.

FIG. 13 is a plan view illustrating a floating unit applied to a battery mounting system according to an embodiment of the present disclosure.

FIG. 14 is a perspective view illustrating first centering units applied to a battery mounting system according to an embodiment of the present disclosure.

FIG. 15 is a front view illustrating first centering units applied to a battery mounting system according to an embodiment of the present disclosure.

FIG. 16 is a perspective view illustrating a second centering unit applied to a battery mounting system according to an embodiment of the present disclosure.

FIG. 17 is a side view illustrating a second centering unit applied to a battery mounting system according to an embodiment of the present disclosure.

FIG. 18 is a perspective view illustrating a first clamper and a second clamper applied to a battery mounting system according to an embodiment of the present disclosure.

FIG. 19 is a plan view illustrating a first clamper and a second clamper applied to a battery mounting system according to an embodiment of the present disclosure.

FIGS. 20 and 21 are perspective views illustrating a tool assembly applied to a battery mounting system according to an embodiment of the present disclosure.

FIG. 22 is a side view illustrating a tool assembly applied to a battery mounting system according to an embodiment of the present disclosure.

FIG. 23 is a front view illustrating a tool assembly applied to a battery mounting system according to an embodiment of the present disclosure.

FIG. 24 is a perspective view illustrating a first position adjusting unit of a tool assembly applied to a battery mounting system according to an embodiment of the present disclosure.

FIG. 25 is a bottom view illustrating a first position adjusting unit of a tool assembly applied to a battery mounting system according to an embodiment of the present disclosure.

FIG. 26 is a perspective view illustrating a second position adjusting unit of a tool assembly applied to a battery mounting system according to an embodiment of the present disclosure.

FIG. 27 is a side view illustrating a second position adjusting unit of a tool assembly applied to a battery mounting system according to an embodiment of the present disclosure.

FIG. 28 is a perspective view illustrating a coupling structure between a skid cart and a shift plate applied to a battery mounting system according to an embodiment of the present disclosure.

It should be understood that the drawings referenced above are not necessarily drawn to scale, but instead present a rather simplified representation of various features illustrating the basic principles of the present disclosure. Specific design features of the present disclosure including, for example, specific sizes, directions, positions, and shapes, will be determined in part according to specifically intended applications and environments of use.

### DETAILED DESCRIPTION OF THE EMBODIMENTS

The present disclosure is described more fully hereinafter with reference to the accompanying drawings, in which several embodiments of the inventive concept are shown. As those of ordinary skill in the art should realize, the described embodiments may be modified in various ways, all without departing from the spirit or scope of the present disclosure. The present disclosure may be implemented in many different forms and is not limited to the embodiments described herein.

The terms used herein are for the purpose of describing specific embodiments only and are not intended to limit the present disclosure. As used herein, singular forms are intended to also include plural forms unless the context clearly indicates otherwise.

It should also be understood that the terms “comprises” and/or “comprising,” when used herein, specify the presence of mentioned features, integers, steps, actions, elements and/or components, but do not exclude the presence or addition of one or more of other features, integers, steps, actions, elements, components, and/or groups thereof. As used herein, the term “and/or” includes any one or all combinations of the associated listed items. When a component, device, element, or the like of the present disclosure is described as having a purpose or performing an operation, function, or the like, the component, device, or element should be considered herein as being “configured to” meet that purpose of perform that operation or function.

In the specification, the term ‘coupled’ indicates the physical relationship between two components directly connected to each other or indirectly connected to each other through one or more intermediate components.

Further, as used herein, ‘operably connected’ or similar terms means that at least two members are directly or indirectly connected to each other and capable of transmitting power. However, two operably connected members do not always rotate at the same speed and in the same direction.

The terms “vehicle,” “of a vehicle,” “automobile”, or other similar terms used herein generally may include passenger automobiles including passenger vehicles, sports utility vehicles (SUVs), buses, trucks, and various commercial vehicles. These automobiles may also include hybrid vehicles, electric vehicles, hybrid electric vehicles, electric vehicle-based purpose built vehicles (PBVs) on which high voltage batteries are mounted and may include hydrogen power vehicles (commonly referred to as ‘hydrogen electric vehicles’ by one of ordinary skill in the art).

Hereinafter, with reference to the accompanying drawings, embodiments of the present disclosure are described in detail.

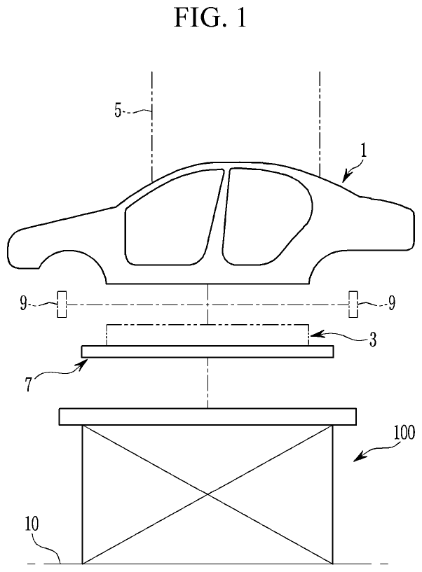

FIG. 1 is a block diagram schematically illustrating an example of a manufacturing process in which a battery mounting system is applied according to an embodiment of the present disclosure.

Referring to FIG. 1, a battery mounting system 100 according to an embodiment of the present disclosure may be applied to a manufacturing process (e.g., a chassis assembly line) in which various design parts are assembled or coupled to a vehicle body 1 of an electric vehicle or an electric vehicle-based purpose built vehicle (PBV).

Furthermore, the battery mounting system 100 according to an embodiment of the present disclosure may be applied to a process of assembling or mounting a battery pack assembly 3 as a high-voltage battery to a lower portion of the vehicle body 1 in the manufacturing process.

In such a battery assembly process, the battery pack assembly 3 may be mounted on the lower portion of the vehicle body 1 transported along a set path by a vehicle body hanger 5 using the battery mounting system 100 according to the embodiment of the present disclosure.

Here, the battery pack assembly 3 may be loaded on a skid cart 7 and may be aligned at a set position of the skid cart 7. Also, the skid cart 7 may be transported to the battery mounting system 100 according to an embodiment of the present disclosure along a set cart line.

The battery mounting system 100 according to the embodiment of the present disclosure may fasten the battery pack assembly 3 loaded on the skid cart 7 to the lower portion of the vehicle body 1 through a plurality of fastening members 9. The plurality of fastening members 9 may be configured as, for example, a combination of bolts and nuts.

Such a battery mounting system 100 according to an embodiment of the present disclosure may be configured in a base frame 10 (typically referred to as a ‘process frame’ by one of ordinary skill in the art) installed on the floor of a process workshop.

In the specification, in an example, reference directions for describing the following components may be set as a vehicle body front and rear direction (e.g., a vehicle body longitudinal direction or a vehicle body transport direction), a vehicle width direction, and an up and down direction (e.g., a height direction).

In addition, in the specification, ‘upper end portion’, ‘upper portion’, ‘upper end’ or ‘upper portion surface’ of a component indicate an end portion, a portion, an end, or a surface of a component located on a relatively upper side in the drawing, and ‘lower end portion’, ‘lower portion’, ‘lower end’ or ‘lower portion surface’ of a component indicate an end portion, a portion, an end, or a surface of a component located on a relatively lower side in the drawing.

Furthermore, in the specification, an end (e.g., one end or another end, etc.) of a component indicates an end of the component in any one direction, and an end portion (e.g., one end portion or the other end portion, etc.) of a component indicates a certain part of the component including its tip.

The battery mounting system 100 according to an embodiment of the present disclosure has a structure capable of reducing investment costs required for manufacturing facilities and improving operation or productivity of manufacturing facilities.

In addition, according to the present disclosure, the battery mounting system 100 has a simple configuration and has a structure capable of accommodating position distribution or variance of the vehicle body 1 and mounting the battery pack assembly 3 on the lower portion of the vehicle body 1. For example, the battery mounting system 100 may allow a position of the battery pack assembly 3 to vary in accordance with a position of the vehicle body 1.

Furthermore, according to the present disclosure, the battery mounting system 100 has a structure capable of ensuring the degree of mounting and safety of mounting of the battery pack assembly 3.

Furthermore, according to the present disclosure, the battery mounting system 100 has a structure capable of mounting the battery pack assembly 3 on the body 1 of various types of vehicles with a single facility (e.g., manufacturing facility).

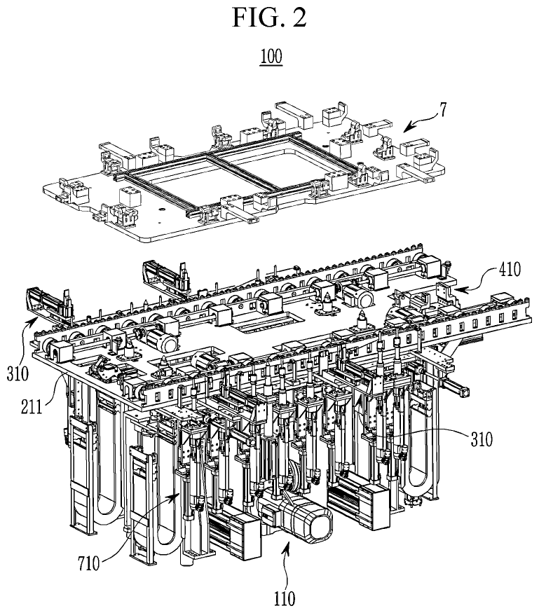

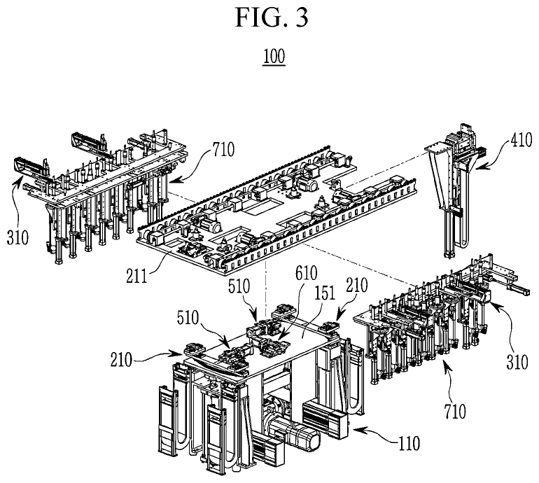

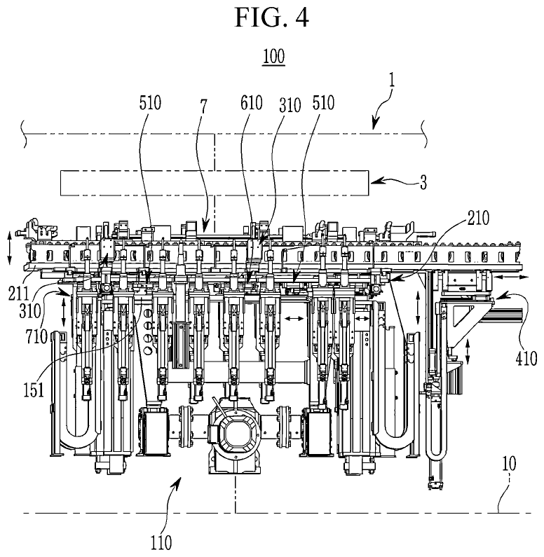

FIG. 2 is a perspective view illustrating a battery mounting system according to an embodiment of the present disclosure. FIG. 3 is an exploded perspective view illustrating the battery mounting system according to an embodiment of the present disclosure. FIG. 4 is a side view illustrating the battery mounting system according to an embodiment of the present disclosure.

Referring to FIGS. 2-4, the battery mounting system 100 according to an embodiment of the present disclosure includes a lifting unit 110, floating units 210, first centering units 310, a second centering unit 410, at least one first clamper 510, at least one second clamper 610, and a tool assembly 710.

In an embodiment of the present disclosure, the lifting unit 110 is configured to lift the battery pack assembly 3 loaded on the skid cart 7 to the lower portion of the vehicle body 1 (hereinafter, see FIG. 4) in the up and down direction.

The lifting unit 110 is installed on a base frame 10. In an example, such a lifting unit 110 may be configured as a push-pull chain lifter converting a rotation motion of a motor into an up-down motion by driving a chain.

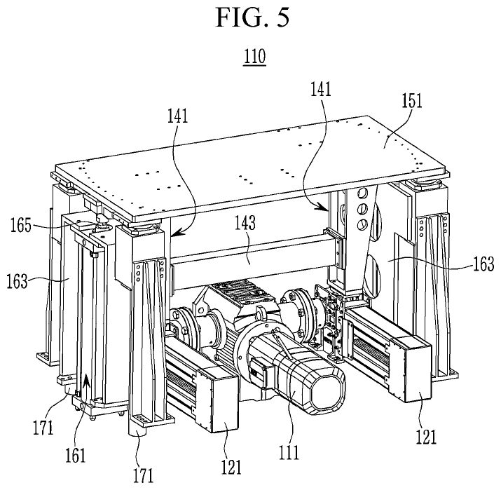

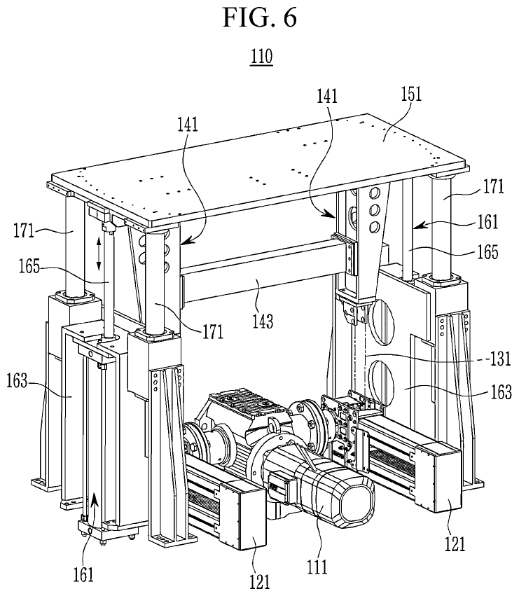

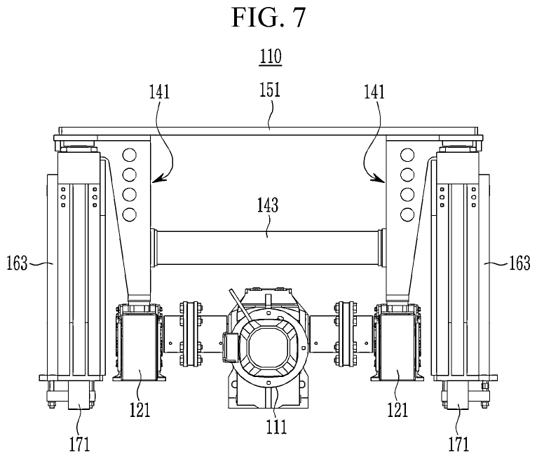

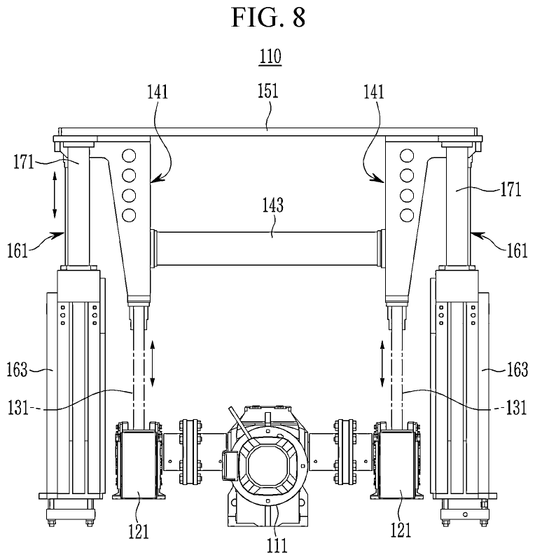

FIGS. 5 and 6 are perspective views illustrating a lifting unit 110 applied to a battery mounting system according to an embodiment of the present disclosure. FIGS. 7 and 8 are side views illustrating the lifting unit 110 applied to the battery mounting system according to an embodiment of the present disclosure.

Referring to FIGS. 5-8, the lifting unit 110 according to an embodiment of the present disclosure includes one servo motor 111, chain winding units 121, push-pull chains 131, lift frames 141, a lift plate 151, safety cylinders 161, and guide shafts 171.

The servo motor 111 may be provided as a motor capable of servo control of rotation position, rotation speed, and rotation direction. The servo motor 111 is fixed to the base frame 10 (hereinafter, see FIG. 4).

The chain winding units 121 are operatively connected to the servo motor 111 and are provided on both sides of the servo motor 111 in the vehicle body front and rear direction.

The push-pull chains 131 are respectively connected to the chain winding units 121. The push-pull chains 131 are configured to travel in the up and down direction by the chain winding units 121 driven by receiving a rotation force from the servo motor 111. The push-pull chains 131 may support a set load acting in the up and down direction.

The lift frames 141 are connected to each push-pull chain 131 and are spaced apart from each other in the vehicle body front and rear direction. The lift frames 141 may be lifted in the up and down direction by the push-pull chains 131 traveling in the up and down direction.

Here, the lift frames 141 may be connected in the vehicle body front and rear direction through at least one cross beam 143.

As described above, a push-pull chain lifter capable of lifting the lift frames 141 in the up and down direction by the at least one servo motor 111, the chain winding units 121, and the push-pull chains 131 should be well known to one of ordinary skill in the art, and thus, further detailed descriptions thereof are omitted.

The lift plate 151 may be connected (e.g., coupled) to the lift frames 141 and may be moved by the lift frames 141 in the up and down direction.

Here, the lift frames 141 may be coupled to both sides of the lift plate 151 in the vehicle body front and rear direction. Upper ends of the lift frames 141 may be coupled to a lower portion of the lift plate 151.

The safety cylinders 161 are configured to prevent the lift frames 141 and the lift plate 151 that are in a raised position from falling in case of failure of the at least one servo motor 111 and the chain winding units 121.

The safety cylinders 161 may include a hydraulic cylinder or a pneumatic cylinder well known to one of ordinary skill in the art.

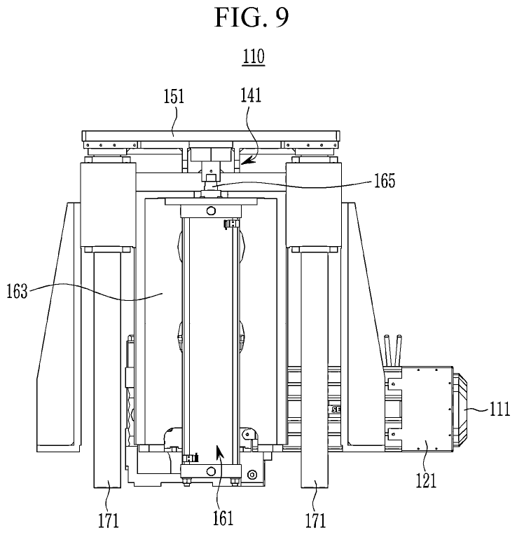

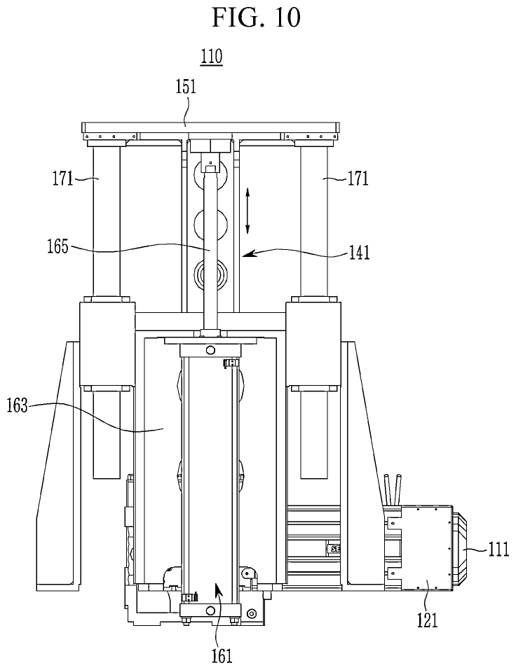

As shown in FIGS. 9 and 10, the safety cylinders 161 are installed in the up and down (e.g., vertical) direction on the mounting frames 163 coupled to both sides of the base frame 10 in the vehicle body front and rear direction. The safety cylinders 161 may be respectively connected (e.g., coupled) to the lift frames 141 through operation rods 165.

When the lift frames 141 and the lift plate 151 lift up, the safety cylinders 161 may move the operation rods 165 forward (e.g., upward) and support the load of the lift frames 141 and the lift plate 151.

Also, when the lift frames 141 and the lift plate 151 move down, the safety cylinders 161 may move the operation rods 165 backward (e.g., downward) and support the load of the lift frames 141 and the lift plate 151.

The guide shafts 171 are configured to guide the lift frames 141 and the lift plate 151 that lift up and down.

The guide shafts 171 are movably mounted on the mounting frames 163 respectively in the up and down direction. The guide shafts 171 may be respectively coupled to lower portions of both sides of the lift plate 151. In one example, such guide shafts 171 may be respectively provided as a pair in the mounting frames 163.

Referring to FIGS. 2-4, according to an embodiment of the present disclosure, the floating units 210 are configured to absorb a position distribution of the vehicle body 1 and the battery pack assembly 3. In other words, the floating units 210 are configured to vary a position of the battery pack assembly 3 in accordance with a position of the vehicle body 1.

Here, floating means that when a fixed first structure is pushed or pulled, a second structure correlated with the first structure is moving (shifting) in accordance with a position of the first structure by a pushing or pulling force.

The floating units 210 are installed on the lift plate 151 of the lifting unit 110 and are coupled to the skid cart 7.

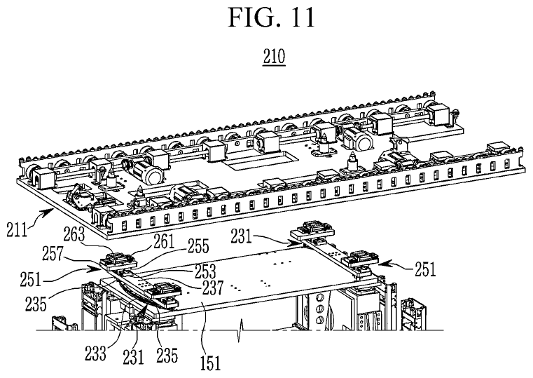

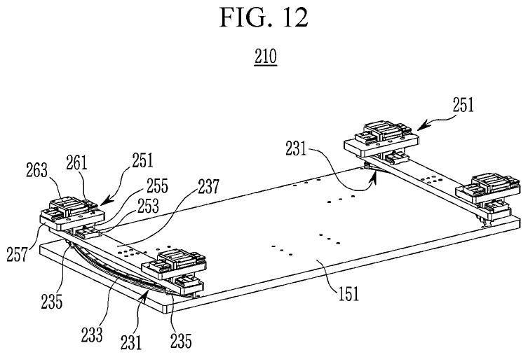

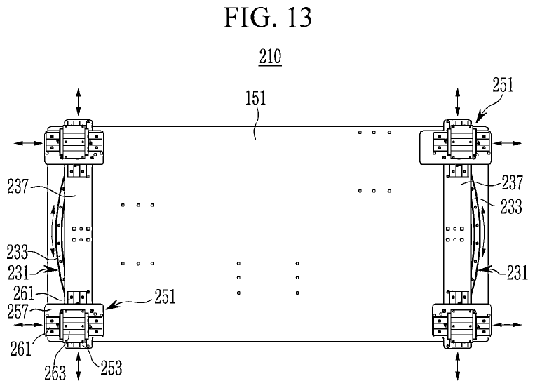

FIGS. 11 and 12 are perspective views illustrating a floating unit applied to a battery mounting system according to an embodiment of the present disclosure. FIG. 13 is a plan view illustrating the floating unit applied to the battery mounting system according to an embodiment of the present disclosure.

Referring to FIGS. 11-13, the floating unit 210 according to an embodiment of the present disclosure includes a shift plate 211, first floating assemblies 231, and second floating assemblies 251.

The shift plate 211 is configured to move on the lift plate 151 in accordance with the position of the vehicle body 1 (hereinafter, see FIG. 4). The shift plate 211 may be coupled to the skid cart 7 (hereinafter, see FIG. 2).

The first floating assemblies 231 are configured to rotate the shift plate 211 on the lift plate 151. The first floating assemblies 231 are installed on the lift plate 151.

The first floating assembly 231 includes an arc guide rail 233, at least one first slider 235, and a first floating plate 237.

The arc guide rail 233 is provided as an arc-shaped rail member. An arc guide rail 233 may be coupled to both sides of an upper surface of the lift plate 151 in the vehicle body front and rear direction.

The at least one first slider 235 is provided in a block shape and is slidably coupled to the arc guide rail 233 in an arc direction. In one example, the at least one first slider 235 may be provided as a pair of first sliders 235.

The first floating plate 237 is coupled to the at least one first slider 235 in a vehicle width direction. The first floating plate 237 is coupled to an upper surface of the at least one first slider 235.

The second floating assemblies 251 are configured to move the shift plate 211 on the lift plate 151 in the vehicle width direction and the vehicle body front and rear direction. The second floating assemblies 251 may be installed (e.g., coupled to) on the first floating assemblies 231 and coupled to the shift plate 211.

The second floating assembly 251 includes at least one first straight guide rail 253, a second slider 255, a second floating plate 257, a second straight guide rail 261, and a third slider 263.

The at least one first straight guide rail 253 is provided as a rail member in a straight line shape and coupled to an upper surface of the first floating plate 237 in the vehicle width direction. In one example, the at least one first straight guide rail 253 may be provided as a pair of straight guide rails 253.

The second slider 255 is provided in a block shape and is slidably coupled to the at least one first straight guide rail 253 in the vehicle width direction.

The second floating plate 257 is coupled to the second slider 255 in the vehicle body front and rear direction. The second floating plate 257 is coupled to an upper surface of the second slider 255.

The second straight guide rail 261 is provided as a rail member in a straight line shape and coupled to an upper surface of the second floating plate 257 in the vehicle body front and rear direction.

Also, the third slider 263 is provided in a block shape and is slidably coupled to the second straight guide rail 261 in the vehicle body front and rear direction. The third slider 263 is coupled to the lower portion of the shift plate 211.

Referring to FIGS. 2-4, according to an embodiment of the present disclosure, the first centering units 310 are configured to push the vehicle body 1 in the vehicle width direction from both sides of the vehicle body 1 in the vehicle width direction, and to adjust centering of the shift plate 211 through the floating unit 210.

The first centering units 310 may apply a pushing force acting on the vehicle body 1 in the vehicle width direction from both sides of the vehicle body 1 in the vehicle width direction. As a result, a reaction force of the pushing force may move the shift plate 211 in the vehicle width direction in accordance with the position of the vehicle body 1 through the floating unit 210.

Also, according to an embodiment of the present disclosure, the second centering unit 410 is configured to pull-push the vehicle body 1 in the vehicle body front and back direction from one side of the vehicle body 1 in the vehicle body front and back direction, and to adjust centering of the shift plate 211 through the floating unit 210.

The second centering unit 410 may apply a pushing force or a pulling force acting in the vehicle body front and back direction from one side of the vehicle body 1 in the vehicle body front and back direction. As a result, a reaction force of the pushing force or the pulling force may move the shift plate 211 in the vehicle body front and back direction in accordance with the position of the vehicle body 1 through the floating unit 210.

Furthermore, the first centering units 310 and the second centering unit 410 may simultaneously operate and simultaneously move and rotate the shift plate 211 in the vehicle width direction and the vehicle body front and back direction in accordance with the position of the vehicle body 1 through the floating unit 210.

In other words, the first centering units 310 and the second centering unit 410 are configured to simultaneously move and rotate the shift plate 211 in the vehicle width direction and the vehicle body front and back direction, and to adjust a position of a fastening part of the battery pack assembly 3 to be coupled to the lower portion of the vehicle body 1 in accordance with the position of the vehicle body 1.

As described above, as the shift plate 211 moves in accordance with the position of the vehicle body 1 by the first centering units 310 and the second centering unit 410, the battery pack assembly 3 loaded in the skid cart 7 coupled to the shift plate 211 may be positioned at the lower portion of the vehicle body 1.

Hereinafter, the configurations of the first centering units 310 and the second centering unit 410 as described above are described in detail with reference to the accompanying drawings.

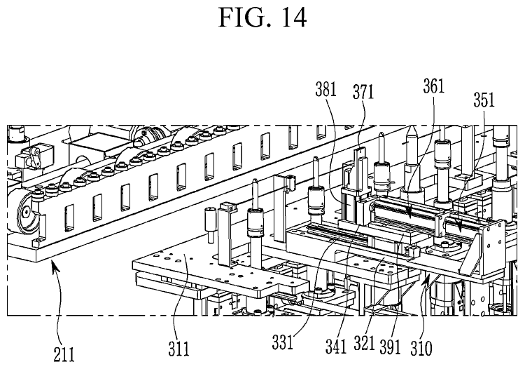

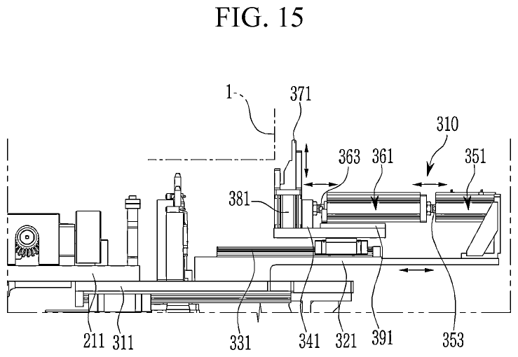

FIG. 14 is a perspective view illustrating first centering units applied to a battery mounting system according to an embodiment of the present disclosure. FIG. 15 is a front view illustrating the first centering units applied to the battery mounting system according to an embodiment of the present disclosure.

Referring to FIGS. 14 and 15, the first centering units 310 according to the embodiment of the present disclosure are respectively installed on both sides of the shift plate 211 in the vehicle width direction.

The first centering unit 310 includes a mounting plate 311, at least one fixed block 321, a push guide rail 331, a moving block 341, a first push cylinder 351, a second push cylinder 361, and a push block 371.

The mounting plates 311 are fixed to both sides of a lower portion of the shift plate 211 in the vehicle width direction. The at least one fixing block 321 is coupled to the mounting plate 311 in the vehicle width direction.

The push guide rail 331 is coupled to the at least one fixing block 321 in the vehicle width direction. The moving block 341 is coupled to the push guide rail 331 to be slidably movable in the vehicle width direction.

The first push cylinder 351 is coupled to the at least one fixing block 321 in the vehicle width direction. In one example, the first push cylinder 351 may be provided as a pneumatic cylinder.

The second push cylinder 361 is connected to the moving block 341 in the vehicle width direction and is connected to the first push cylinder 351 in the vehicle width direction. In one example, the second push cylinder 361 may be provided as a pneumatic cylinder.

Here, the first push cylinder 351 may be connected to the second push cylinder 361 through an operation rod 353. Also, the second push cylinder 361 may be connected to the moving block 341 through an operation rod 363.

The push block 371 is configured to push the vehicle body 1 in the vehicle width direction. The push block 371 is installed on the moving block 341 to be reciprocally movable in the up and down direction.

The push block 371 may be reciprocally moved in the up and down direction by an up-down cylinder 381. The up-down cylinder 381 is coupled to the moving block 341 in the up and down direction and is connected to the push block 371. In one example, the up-down cylinder 381 may be provided as a pneumatic cylinder.

Furthermore, the first centering unit 310 according to an embodiment of the present disclosure further includes a guide plate 391 disposed between the second push cylinder 361 and the moving block 341.

The guide plate 391 supports a lower portion of the second push cylinder 361. The guide plate 391 is coupled to an upper surface of the moving block 341 and contacts the lower portion of the second push cylinder 361.

Therefore, when the operation rod 353 of the first push cylinder 351 moves forward, the moving block 341 together with the second push cylinder 361 moves in the vehicle width direction along the push guide rail 331, and the push block 371 moves to a position in contact with the vehicle body 1.

Also, when the operation rod 363 of the second push cylinder 361 moves forward, the moving block 341 is pressed by the operation rod 363. The push block 371 pushes the vehicle body 1 in the vehicle width direction through the moving block 341.

Here, the second push cylinder 361 moves along the guide plate 391 in a direction opposite to a direction in which the push block 371 is pushed while being connected to the first push cylinder 351. In other words, the second push cylinder 361 may apply a reaction force to the force pushing the vehicle body 1 to the at least one fixing block 321 through the first push cylinder 351. Accordingly, the shift plate 211 moves in the vehicle width direction in accordance with the position of the vehicle body 1 through the floating unit 210 (see FIG. 3).

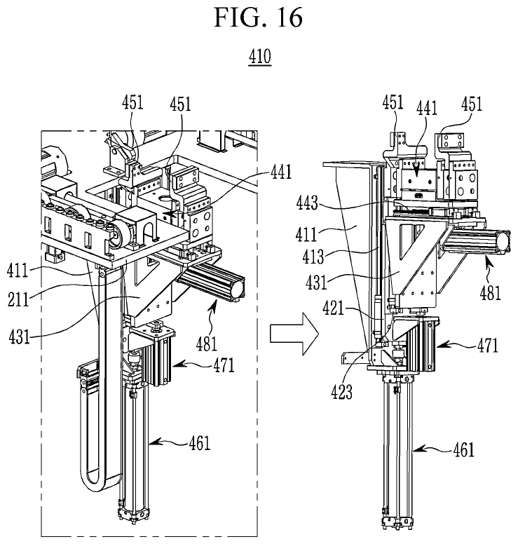

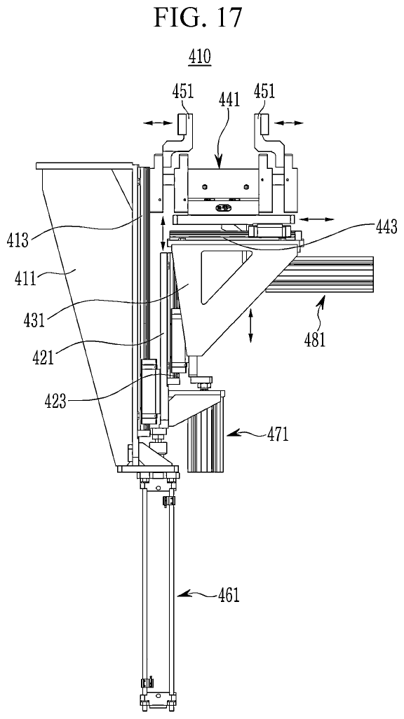

FIG. 16 is a perspective view illustrating a second centering unit applied to a battery mounting system according to an embodiment of the present disclosure. FIG. 17 is a side view illustrating the second centering unit applied to the battery mounting system according to an embodiment of the present disclosure.

Referring to FIGS. 16 and 17, according to an embodiment of the present disclosure, the second centering unit 410 is installed on one side of the shift plate 211 in the vehicle body front and rear direction.

The second centering unit 410 includes a fixed bracket 411, a first moving bracket 421, a second moving bracket 431, a gripper cylinder 441, a pair of pull-push grippers 451, a main vertical cylinder 461, a sub vertical cylinder 471, and a horizontal cylinder 481.

The fixing bracket 411 is coupled, in the up and down direction, to a lower portion of one side of the shift plate 211 in the vehicle body front and rear direction.

The first moving bracket 421 is coupled to the fixed bracket 411 to be movable in the up and down direction. The first moving bracket 421 may be coupled to at least one first vertical guide rail 413 fixed to the fixing bracket 411 to be slidably movable in the up and down direction.

The second moving bracket 431 is coupled to the first moving bracket 421 to be movable in the up and down direction. The second moving bracket 431 may be coupled to at least one second vertical guide rail 423 fixed to the first moving bracket 421 to be slidably movable in the up and down direction.

The gripper cylinder 441 is coupled to an upper portion of the second moving bracket 431 to be movable in the vehicle body front and rear direction. The gripper cylinder 441 may be coupled to at least one horizontal guide rail 443 fixed to the upper portion of the second moving bracket 431 in the vehicle body front and rear direction to be slidably movable. In one example, the gripper cylinder 441 may be provided as a pneumatic cylinder.

Here, the gripper cylinder 441 may be moved in the up and down direction by the second moving bracket 431 and may be moved in the vehicle body front and rear direction through the at least one horizontal guide rail 443. In other words, the gripper cylinder 441 may be installed on the shift plate 211 to be reciprocally movable in the vehicle body front and rear direction and the up and down direction.

The pair of pull-push grippers 451 is configured to grip one side of the vehicle body 1 from one side of the shift plate 211 in the vehicle body front and rear direction and pull-push one side of the vehicle body 1 in the vehicle body front and rear direction.

The pair of pull-push grippers 451 may be operatively connected to the gripper cylinder 441 and may be installed to be movable in a direction away from or closer to each other in the vehicle body front and rear direction by the operation of the gripper cylinder 441.

The main vertical cylinder 461 is configured to reciprocally move the first moving bracket 421 in the up and down direction along the at least one first vertical guide rail 413.

The main vertical cylinder 461 is coupled to the fixed bracket 411 in the up and down direction and is connected to the first moving bracket 421. In one example, the main vertical cylinder 461 may be provided as a pneumatic cylinder.

The sub vertical cylinder 471 is configured to reciprocally move the second moving bracket 431 in the up and down direction along the at least one second vertical guide rail 423.

The sub vertical cylinder 471 is coupled to the first moving bracket 421 in the up and down direction and is connected to the second moving bracket 431. In one example, the sub vertical cylinder 471 may be provided as a pneumatic cylinder.

The horizontal cylinder 481 is configured to reciprocally move the gripper cylinder 441 along the at least one horizontal guide rail 443 in the vehicle body front and rear direction.

The horizontal cylinder 481 is coupled to the second moving bracket 431 in the vehicle body front and rear direction and is connected to the gripper cylinder 441. In one example, the horizontal cylinder 481 may be provided as a pneumatic cylinder.

Accordingly, the gripper cylinder 441 moves in an upward direction through the first moving bracket 421 and the second moving bracket 431 by the operation of the main vertical cylinder 461 and the sub vertical cylinder 471. In addition, the gripper cylinder 441 moves to a position corresponding to the lower portion of the vehicle body 1 by the operation of the horizontal cylinder 481.

Also, the pair of pull-push grippers 451 moves in a direction closer to each other in the vehicle body front and rear direction by the operation of the gripper cylinder 441 and pulls-pushes the lower portion of the vehicle body 1 in the vehicle body front and rear direction.

Here, the pair of pull-push grippers 451 applies a pushing force or a pulling force to the lower portion of the vehicle body 1. In other words, the pair of pull-push grippers 451 applies a reaction force to the force pushing or pulling the lower portion of the vehicle body 1 to the shift plate 211. Accordingly, the shift plate 211 moves in the vehicle body front and rear direction in accordance with the position of the vehicle body 1 through the floating unit 210 (see FIG. 3).

Referring to FIGS. 2-4, according to an embodiment of the present disclosure, the at least one first clamper 510 and the at least one second clamper 610 are configured to fix (e.g., clamp) the shift plate 211 moved in accordance with the position of the vehicle body 1 to the lift plate 151 by the floating unit 210, the first centering units 310, and the second centering unit 410.

Here, the at least one first clamper 510 is configured to clamp the shift plate 211 having the adjusted centering in the vehicle body front and rear direction. Also, the at least one second clamper 610 is configured to clamp the shift plate 211 having the adjusted centering in the vehicle width direction.

Hereinafter, the configurations of the at least one first clamper 510 and the at least one second clamper 610 as described above are described in detail with reference to the accompanying drawings.

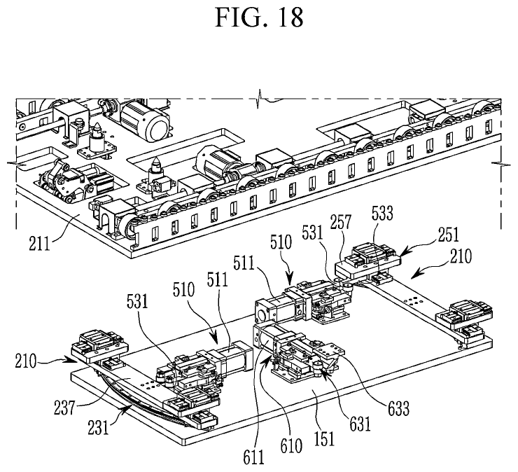

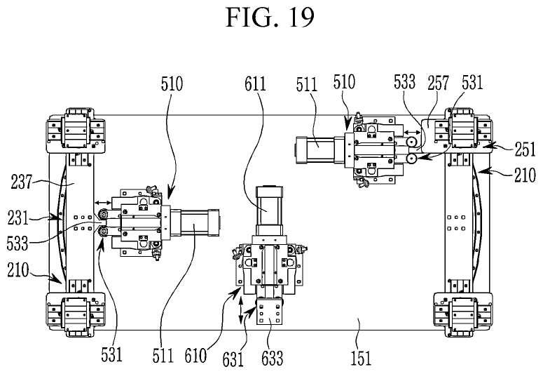

FIG. 18 is a perspective view illustrating a first clamper and a second clamper applied to a battery mounting system according to an embodiment of the present disclosure. FIG. 19 is a plan view illustrating the first clamper and the second clamper applied to the battery mounting system according to an embodiment of the present disclosure.

Referring to FIGS. 18 and 19, the at least one first clamper 510 according to an embodiment of the present disclosure is installed on an upper surface of the lift plate 151.

In one example, the at least one first clamper 510 may be respectively installed on both sides of the upper surface of the lift plate 151 in the vehicle body front and rear direction.

The at least one first clamper 510 includes a first clamping cylinder 511 and a pair of first clamping rollers 531.

The first clamping cylinder 511 is coupled to the upper surface of the lift plate 151 in the vehicle body front and rear direction. In one example, the first clamping cylinder 511 may be provided as a pneumatic cylinder.

The pair of first clamping rollers 531 is connected to the first clamping cylinder 511. The pair of first clamping rollers 531 may clamp a first dog block 533 coupled or substantially connected to the shift plate 211.

Here, the first dog block 533 may be coupled to the first floating plate 237 of the first floating assembly 231 substantially connected to the shift plate 211. Also, the first dog block 533 may be coupled to the second floating plate 257 of the second floating assembly 251 substantially connected to the shift plate 211.

The at least one second clamper 610 according to an embodiment of the present disclosure is installed on the upper surface of the lift plate 151 together with the at least one first clamper 510.

In one example, the at least one second clamper 610 may be installed on one side of the upper surface of the lift plate 151 in the vehicle width direction.

The at least one second clamper 610 includes a second clamping cylinder 611 and a pair of second clamping rollers 631.

The second clamping cylinder 611 is coupled to the upper surface of the lift plate 151 in the vehicle width direction. In one example, the second clamping cylinder 611 may be provided as a pneumatic cylinder.

The pair of second clamping rollers 631 is connected to the second clamping cylinder 611. The pair of second clamping rollers 631 may clamp a second dog block 633 coupled or substantially connected to the shift plate 211.

Here, the second dog block 633 may be coupled to a lower portion of the shift plate 211.

Referring to FIGS. 2-4, according to an embodiment of the present disclosure, the tool assembly 710 is configured to fasten the battery pack assembly 3 positioned in the lower portion of the vehicle body 1 to the lower portion of the vehicle body 1 by the floating unit 210, the first centering units 310, and the second centering unit 410.

The tool assemblies 710 are respectively installed on both sides of the shift plate 211 in the vehicle width direction. Here, the tool assemblies 710 may fasten the battery pack assembly 3 to the lower portion of the vehicle body 1 through the plurality of fastening members 9 as shown in FIG. 1.

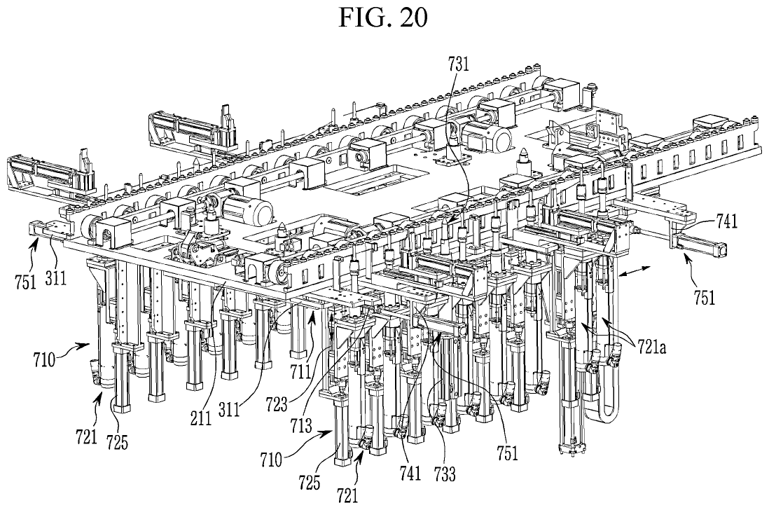

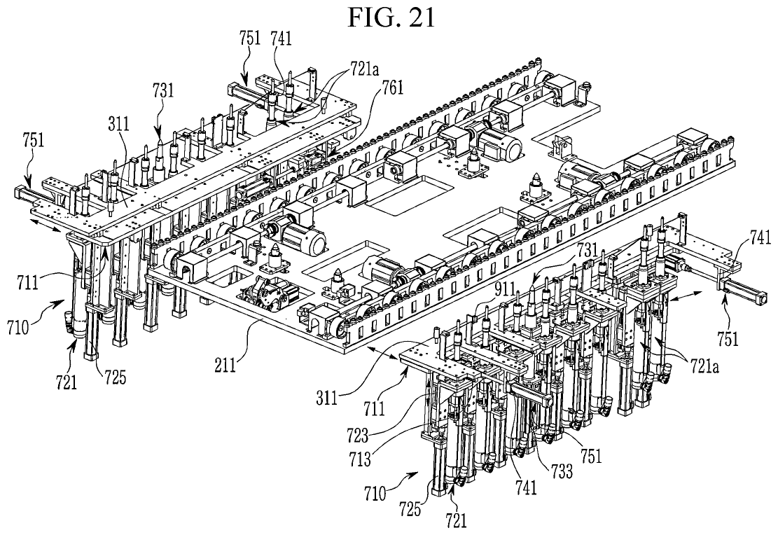

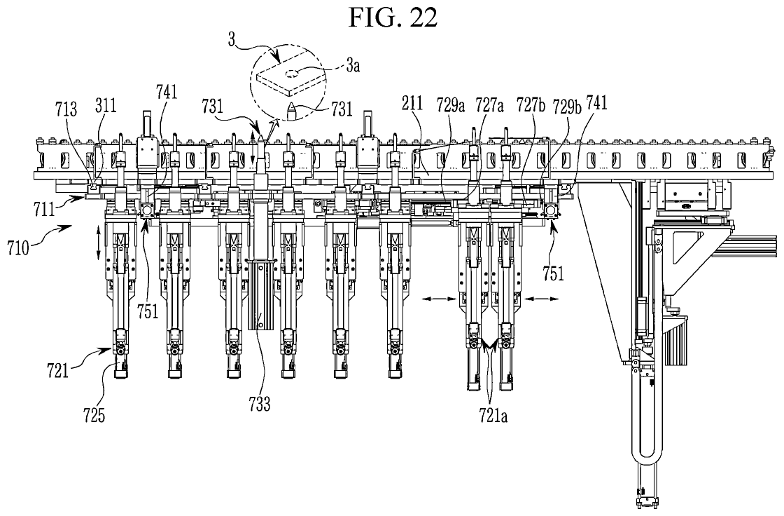

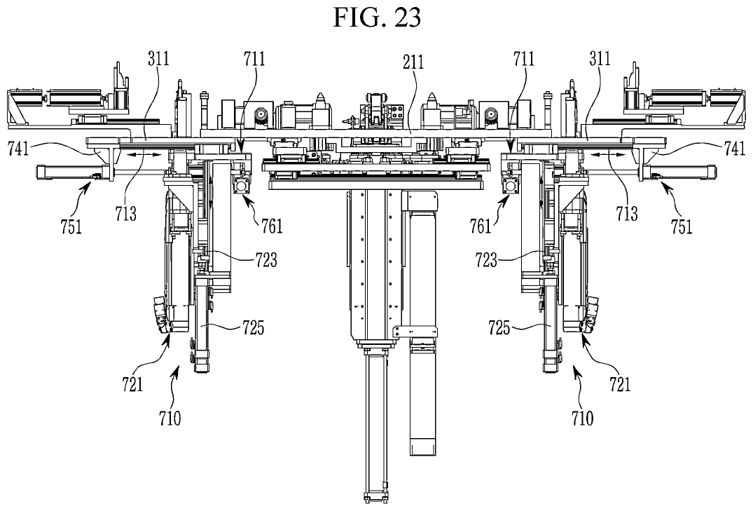

FIGS. 20 and 21 are perspective views illustrating a tool assembly applied to a battery mounting system according to an embodiment of the present disclosure. FIG. 22 is a side view illustrating the tool assembly applied to the battery mounting system according to an embodiment of the present disclosure. FIG. 23 is a front view illustrating the tool assembly applied to the battery mounting system according to an embodiment of the present disclosure.

Referring to FIGS. 20-23, the tool assembly 710 according to an embodiment of the present disclosure includes slide plates 711, a plurality of nut runners 721, at least one master pin 731, at least one mounting block 741, a first position adjusting unit 751, and a second position adjusting unit 761.

The slide plates 711 are installed on the mounting plates 311 coupled to both sides of the shift plate 211 in the vehicle width direction. The slide plates 711 are respectively coupled to the mounting plates 311 to be slidably movable in the vehicle width direction.

The slide plates 711 may be coupled to a plurality of first rail blocks 713 fixed to lower portions of the mounting plates 311 in the vehicle width direction to be slidably movable.

The plurality of nut runners 721 are configured to support the plurality of fastening members 9 (hereinafter, see FIG. 1) and apply an electric rotation force to the plurality of fastening members 9. Configurations of the plurality of nut runners 721 are well known to one of ordinary skill in the art, and thus, further detailed descriptions thereof are omitted.

Here, the plurality of nut runners 721 are installed (e.g., arranged) on the slide plate 711 in the vehicle body front and rear direction, and are provided to be reciprocally movable in the up and down direction. The plurality of nut runners 721 may be respectively coupled to second rail blocks 723 fixed to the slide plates 711 in the up and down direction to be slidably movable.

Also, the plurality of nut runners 721 are respectively connected to first operation cylinders 725 coupled to the slide plates 711. The plurality of nut runners 721 may be reciprocally moved in the up and down direction along the second rail blocks 723 respectively by the operation of the first operation cylinders 725. In one example, the first operation cylinder 725 may be provided as a pneumatic cylinder.

The at least one master pin 731 is configured to align with the battery pack assembly 3 in the lower portion of the vehicle body 1 (hereinafter, refer to FIG. 4). The at least one master pin 731 may be inserted into a master hole 3a formed in the battery pack assembly 3 in the up and down direction.

The at least one master pin 731 is installed on the slide plate 711 to be movable in the up and down direction. The at least one master pin 731 is connected to a second operation cylinder 733 coupled to the slide plate 711.

The at least one master pin 731 may be reciprocally moved in the up and down direction by the operation of the second operation cylinder 733. In one example, the second operation cylinder 733 may be provided as a pneumatic cylinder.

Meanwhile, a pair of nut runners 721a among the plurality of nut runners 721 may be respectively coupled to the slide plates 711 to be slidably movable in the vehicle body front and rear direction.

The pair of nut runners 721a may be respectively coupled to the slide plates 711 in the vehicle body front and rear direction through sliding blocks 727a and 727b.

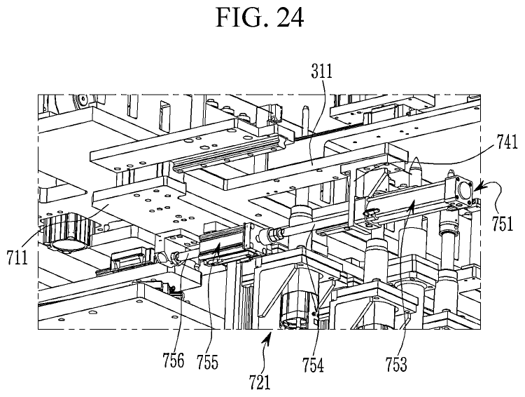

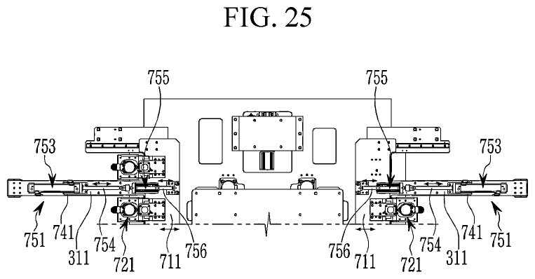

FIG. 24 is a perspective view illustrating a first position adjusting unit of a tool assembly applied to a battery mounting system according to an embodiment of the present disclosure. FIG. 25 is a bottom view illustrating the first position adjusting unit of the tool assembly applied to the battery mounting system according to an embodiment of the present disclosure.

Referring to FIGS. 20-25, the at least one mounting block 741 is fixed to the mounting plate 311 mentioned above.

The first position adjusting unit 751 according to an embodiment of the present disclosure is configured to adjust a position of the slide plate 711 on which the plurality of nut runners 721 are mounted in the vehicle width direction.

Furthermore, the first position adjusting unit 751 may adjust the position of the slide plate 711 in the vehicle width direction so that the plurality of fastening members 9 (hereinafter, see FIG. 1) may be set to the plurality of nut runners 721.

Furthermore, the first position adjusting unit 751 may move the slide plate 711 in accordance with a position of the battery pack assembly 3 (hereinafter, see FIG. 4) to be mounted on the lower portion of the vehicle body 1 (hereinafter, see FIG. 4) in the vehicle width direction, and adjust positions of the plurality of nut runners 721 in the vehicle width direction.

The first position adjusting unit 751 is installed on the at least one mounting block 741. The first position adjusting unit 751 includes a first position adjusting cylinder 753 and a second position adjusting cylinder 755.

The first position adjusting cylinder 753 is coupled to the at least one mounting block 741 in the vehicle width direction. In one example, the first position adjusting cylinder 753 may be provided as a pneumatic cylinder.

The second position adjusting cylinder 755 is connected to the first position adjusting cylinder 753 in the vehicle width direction and is connected to the slide plate 711 in the vehicle width direction. In one example, the second position adjusting cylinder 755 may be provided as a pneumatic cylinder.

Here, the first position adjusting cylinder 753 may be connected to the second position adjusting cylinder 755 through an operation rod 754. Also, the second position adjusting cylinder 755 may be connected to the slide plate 711 through an operation rod 756.

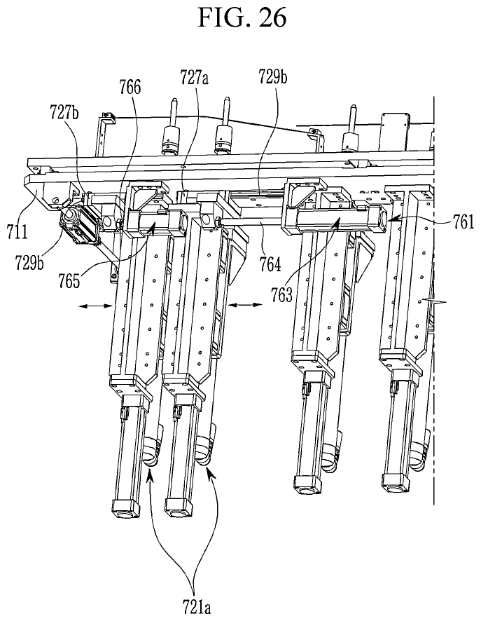

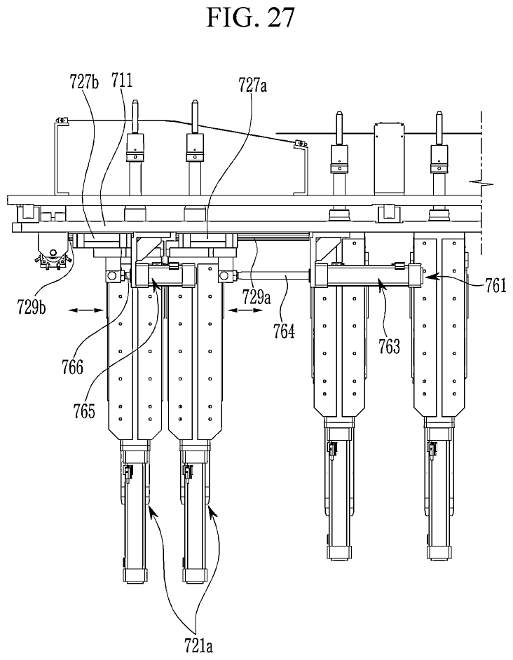

FIG. 26 is a perspective view illustrating a second position adjusting unit of a tool assembly applied to a battery mounting system according to an embodiment of the present disclosure. FIG. 27 is a side view illustrating the second position adjusting unit of the tool assembly applied to the battery mounting system according to an embodiment of the present disclosure.

Referring to FIGS. 26 and 27 together with FIGS. 20-23, the second position adjusting unit 761 according to an embodiment of the present disclosure is configured to adjust the positions of the pair of nut runners 721a mentioned above in the vehicle body front and rear direction.

The second position adjusting unit 761 is installed on the slide plate 711. The second position adjusting unit 761 includes a third position adjusting cylinder 763 and a fourth position adjusting cylinder 765.

Here, the pair of nut runners 721a may be respectively coupled to third rail blocks 729a and 729b fixed to the slide plate 711 in the vehicle body front and rear direction to be slidably movable through sliding blocks 727a and 727b.

The third position adjusting cylinder 763 is coupled to the slide plate 711 in the vehicle body front and rear direction and is connected to one of the pair of nut runners 721a.

The third position adjusting cylinder 763 may be connected to the sliding block 727a through an operation rod 764. In one example, the third position adjusting cylinder 763 may be provided as a pneumatic cylinder.

Also, the fourth position adjusting cylinder 765 is coupled to the slide plate 711 in the vehicle body front and rear direction at a position corresponding to the third position adjusting cylinder 763 and is connected to the other of the pair of nut runners 721a.

The fourth position adjusting cylinder 765 may be connected to the sliding block 727b through an operation rod 766. In one example, the fourth position adjusting cylinder 765 may be provided as a pneumatic cylinder.

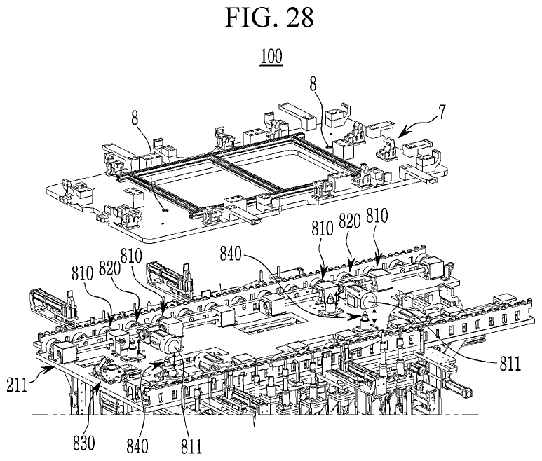

FIG. 28 is a perspective view illustrating a coupling structure between a skid cart and a shift plate applied to a battery mounting system according to an embodiment of the present disclosure.

Referring to FIG. 28, a battery mounting system 100 according to an embodiment of the present disclosure further includes a plurality of driving wheels 810 and a plurality of idle wheels 820, at least one cart clamper 830, and at least one tooling pin 840 installed on the shift plate 211.

In an embodiment of the present disclosure, the plurality of driving wheels 810 and the plurality of idle wheels 820 are configured to move the skid cart 7 transported through a set cart line onto the shift plate 211.

The plurality of driving wheels 810 and the plurality of idle wheels 820 are installed on both edges of the shift plate 211 in the vehicle body front and rear direction. The plurality of driving wheels 810 and the plurality of idle wheels 820 are disposed in the vehicle body front and rear direction at set intervals.

Here, the plurality of driving wheels 810 are connected to a plurality of wheel driving motors 811. The plurality of driving wheels 810 may be in rolling contact with a lower portion of the skid cart 7 and may be driven and rotated by driving of the plurality of wheel driving motors 811.

The plurality of idle wheels 820 are respectively disposed between the plurality of driving wheels 810. The plurality of idle wheels 820 may be in rolling contact with the lower portion of the skid cart 7 and may be in idle rotation by the moving skid cart 7.

In an embodiment of the present disclosure, the at least one cart clamper 830 is configured to clamp the skid cart 7 to the shift plate 211. The at least one cart clamper 830 is installed on the shift plate 211.

In one example, the at least one cart clamper 830 may rotate in the vehicle body front and rear direction by pneumatic or hydraulic pressure and may clamp one side of the skid cart 7 in the vehicle body front and rear direction.

The at least one tooling pin 840 is configured to align the skid cart 7 on the shift plate 211. The at least one tooling pin 840 is installed on the shift plate 211 to be movable in the up and down direction.

Here, the at least one tooling pin 840 may be inserted into a tooling hole 8 formed in the skid cart 7 in the up and down direction. The at least one tooling pin 840 may be connected to a tooling cylinder (not shown) installed on the shift plate 211 and may be reciprocally moved in the up and down direction by the operation of the tooling cylinder.

Hereinafter, the operation of the battery mounting system 100 according to an embodiment of the present disclosure configured as described above is described in detail with reference to FIGS. 1-28.

First, in a battery assembly process of a manufacturing process of an automobile production plant, the vehicle body 1 is transported along the set vehicle body transport path by the body hanger 5. The vehicle body 1 is positioned on an upper side of (e.g., above) the battery mounting system 100 according to the embodiment of the present disclosure.

Here, the lift plate 151 of the lifting unit 110 is in a state of being moved in a downward direction (e.g., downward state) together with the lift frame 141 by the push-pull chain 131 (e.g., a lift-down state).

The push-pull chain 131 is in a state of traveling in the downward direction by the chain winding unit 121 driven by receiving a rotation force from the one servo motor 111 and moving the lift frame 141 together with the lift plate 151 in the downward direction (e.g., downward state).

And, the operation rod 165 of the safety cylinder 161 is in a state of being moved backward in the downward direction. Furthermore, since the floating unit 210 is installed on the lift plate 151, the floating unit 210 is in a state of being moved downward along with the lift plate 151.

Meanwhile, the push block 371 of the first centering unit 310 is in a state of being moved backward in the vehicle width direction by backward operations of the first push cylinder 351 and the second push cylinder 361.

And, the gripper cylinder 441 of the second centering unit 410 is in a state of being moved backward in the downward direction by backward operations of the main vertical cylinder 461 and the sub vertical cylinder 471.

In addition, the gripper cylinder 441 is in a state of being moved backward in the vehicle body front and rear direction by a backward operation of the horizontal cylinder 481 or being moved forward in the vehicle body front and rear direction by a forward operation of the horizontal cylinder 481.

Furthermore, the pair of pull-push grippers 451 is in a state of being moved in a direction away from each other along the vehicle body front and rear direction by an operation of the gripper cylinder 441.

On the other hand, the pair of first clamping rollers 531 of the at least one first clamper 510 is in a state of being moved backward in the vehicle body front and rear direction by a backward operation of the first clamping cylinder 511.

Also, the pair of second clamping rollers 631 of the at least one second clamper 610 is in a state of being moved backward in the vehicle width direction by a backward operation of the second clamping cylinder 611.

On the other hand, the plurality of nut runners 721 of the tool assembly 710 is in a state of being moved in the downward direction by an operation of the first operation cylinder 725.

And, the at least one master pin 731 is in a state of being moved in the downward direction by an operation of the second operation cylinder 733.

In this state, the skid cart 7 is transported along a set cart line and enters the shift plate 211 of the floating unit 210 in the vehicle body front and rear direction. Here, the battery pack assembly 3 is in a state of being loaded and aligned on the skid cart 7.

At this time, the skid cart 7 is transported to a set position in the vehicle body front and rear direction on the shift plate 211 by driving rotation of the plurality of driving wheels 810 and idle rotation of the plurality of idle wheels 820.

Then, the at least one cart clamper 830 clamps the skid cart 7 positioned on the shift plate 211.

In addition, the at least one tooling pin 840 is inserted into the tooling hole 8 of the skid cart 7 while moving in the upward direction in a state of being moved in the downward direction.

Accordingly, the skid cart 7 remains in a state of clamped and aligned at the set position on the shift plate 211.

Next, the lift plate 151 of the lifting unit 110 is moved in the upward direction together with the lift frame 141 by the push-pull chain 131 (e.g., a lift-up state).

The push-pull chain 131 may travel in the upward direction by the chain winding unit 121 driven by receiving a rotation force from the one servo motor 111 and move the lift frame 141 together with the lift plate 151 in the upward direction.

Also, the safety cylinder 161 moves the operation rod 165 forward in the upward direction when the lift frame 141 and the lift plate 151 lift up.

Thus, the safety cylinder 161 may stably support the load of the lift frame 141 and the lift plate 151.

Here, since the floating unit 210 is installed on the lift plate 151, the floating unit 210 moves in the upward direction together with the lift plate 151.

Furthermore, the guide shaft 171 may guide the lift-up of the lift frame 141 and the lift plate 151 and the forward movement of the operation rod 165 of the safety cylinder 161 and may stably support the load of the lift frame 141 and the lift plate 151.

As the lift plate 151 moves in the upward direction as described above, the shift plate 211 of the floating unit 210 moves in the upward direction.

Then, the battery pack assembly 3 loaded on the skid cart 7 coupled to the shift plate 211 moves in the upward direction by the shift plate 211 and is positioned on the lower portion of the vehicle body 1.

In this state, when the operation rod 353 of the first push cylinder 351 of the first centering unit 310 moves forward, the moving block 341 together with the second push cylinder 361 moves forward in the vehicle width direction along the push guide rail 331. At this time, the push block 371 moves forward to a position in contact with the lower portion of the vehicle body 1.

In this case, the push block 371 may be moved to a position in contact with the lower portion of the vehicle body 1 while being moved in the up and down direction by the operation of the up-down cylinder 381 so as to be disposed at a position corresponding to the lower portion of the vehicle body 1.

And, when the operation rod 363 of the second push cylinder 361 is moved forward, the moving block 341 is pressed by the operation rod 363, and the push block 371 pushes the vehicle body 1 in the vehicle width direction through the moving block 341.

Here, the second push cylinder 361 moves along the guide plate 391 in a direction opposite to a direction in which the push block 371 is pushed while being connected to the first push cylinder 351. In other words, the second push cylinder 361 applies a reaction force from the force pushing the vehicle body 1 to the at least one fixing block 321 through the first push cylinder 351.

Accordingly, the shift plate 211 is moved in the vehicle width direction according to the position of the vehicle body 1 through the mounting plate 311 and the floating unit 210. The operation of the floating unit 210 is described in detail below.

During the above process, in a state where the gripper cylinder 441 of the second centering unit 410 is in a state of being moved in the downward direction, the first moving bracket 421 is moved in the upward direction together with the gripper cylinder 441 by the operation of the main vertical cylinder 461.

Then, the second moving bracket 431 is moved in the upward or downward direction together with the gripper cylinder 441 by the operation of the sub vertical cylinder 471 and is disposed at the position corresponding to the lower portion of the vehicle body 1.

In addition, the gripper cylinder 441 is moved in the vehicle body front and rear direction by the operation of the horizontal cylinder 481 and is disposed at the position corresponding to the lower portion of the vehicle body 1.

Next, the pair of pull-push grippers 451 is moved in a direction closer to each other in the vehicle body front and rear direction by the operation of the gripper cylinder 441 while being moved in a direction away from each other.

Here, the pair of pull-push grippers 451 applies a pushing force or pulling force acting in the vehicle body front and rear direction to the lower portion of the vehicle body 1 from one side of the vehicle body 1 in the vehicle body front and rear direction. In other words, the pair of pull-push grippers 451 applies a reaction force from a force pushing or pulling the lower portion of the vehicle body 1 to the shift plate 211 in the vehicle body front and rear direction.

Accordingly, the shift plate 211 is moved in the vehicle body front and rear direction through the floating unit 210 in accordance with the position of the vehicle body 1. The operation of the floating unit 210 is described in detail below.

Thus, the first centering unit 310 and the second centering unit 410 as described above may simultaneously move and rotate the shift plate 211 in the vehicle width direction and the front and rear direction of the vehicle body through the first floating assembly 231 and the second floating assembly 251 of the floating unit 210.

Upon describing the operation of the floating unit 210 in detail, the first floating plate 237 of the first floating assembly 231 is slidably moved in an arc direction along the arc guide rail 233 through the at least one first slider 235.

Also, the second floating plate 257 of the second floating assembly 251 is slidably moved in the vehicle width direction along the at least one first straight guide rail 253 through the second slider 255.

In addition, the third slider 263 coupled to the shift plate 211 is slidably moved in the vehicle body front and rear direction along the second straight guide rail 261.

Accordingly, the shift plate 211 is moved in the vehicle body front and rear direction and the vehicle width direction and is simultaneously rotated with respect to the center and is positioned at the lower portion of the vehicle body 1.

As a result, the battery pack assembly 3 loaded on the skid cart 7 coupled to the shift plate 211 is positioned on the lower portion of the vehicle body 1.

In the above state, the first clamping cylinder 511 of the at least one first clamper 510 operates forward and moves the pair of first clamping rollers 531 forward in the vehicle body front and rear direction.

Then, the pair of first clamping rollers 531 clamps the first dog block 533 coupled to the first floating plate 237 of the first floating assembly 231 and/or the second floating plate 257 of the second floating assembly 251.

At the same time, the second clamping cylinder 611 of the at least one second clamper 610 moves forward and moves the pair of second clamping rollers 631 forward in the vehicle width direction.

Accordingly, the pair of second clamping rollers 631 clamps the second dog block 633 coupled to the shift plate 211.

As the battery pack assembly 3 is positioned in accordance with the position of the vehicle body 1 by the operation described above, the lower portion of the vehicle body 1 and a fastening part of the battery pack assembly 3 remain in a state of being mutually matched in the up and down direction.

Here, the fastening part means a plurality of mounting bolts coupled to the lower portion of the vehicle body 1 and bolt fastening holes formed in the battery pack assembly 3. Also, the mutually matched state means a state in which the plurality of mounting bolts are inserted into the bolt fastening holes.

Next, the first position adjusting cylinder 753 of the first position adjusting unit 751 of the tool assembly 710 operates backward and moves the slide plate 711 on which the plurality of nut runners 721 and the at least one master pin 731 are mounted backward in the vehicle width direction. At this time, the second position adjusting cylinder 755 is moved backward in the vehicle width direction together with the slide plate 711.

Accordingly, the plurality of fastening members 9 are set (e.g., mounted) to the plurality of nut runners 721 moved backward through the slide plate 711.

Then, the first position adjusting cylinder 753 moves forward and moves the slide plate 711 forward in the vehicle width direction.

Subsequently, the second position adjusting cylinder 755 operates forward and backward in the vehicle width direction and moves the slide plate 711 forward and backward in the vehicle width direction.

Then, the plurality of nut runners 721 and the at least one master pin 731 mounted on the slide plate 711 are moved to positions corresponding to the lower portion of the vehicle body 1 and the fastening part of the battery pack assembly 3.

Here, adjustment of the position of the slide plate 711 in the vehicle width direction by the second position adjusting cylinder 755 may be implemented by detection signals of a plurality of sensors 911 installed on the mounting plate 311.

During the above process, the third position adjusting cylinder 763 and the fourth position adjusting cylinder 765 of the second position adjusting unit 761 operate forward and backward and adjust the position of the pair of nut runners 721a in the vehicle body front and rear direction.

The adjustment of the position of the pair of nut runners 721a may be implemented by the detection signals of the plurality of sensors 911 described above.

Next, each of the plurality of nut runners 721 is moved in the upward direction by the forward operation of the first operation cylinder 725.

Also, the at least one master pin 731 is moved in the upward direction by the forward operation of the second operation cylinder 733.

Here, the at least one master pin 731 is inserted into the master hole 3a formed in the battery pack assembly 3 in the up and down direction and aligns the battery pack assembly 3 on the lower portion of the vehicle body 1.

Accordingly, the plurality of nut runners 721 fasten the battery pack assembly 3 to the lower portion of the vehicle body 1 through the plurality of fastening members 9.

Thus, the battery mounting system 100 according to the embodiment of the present disclosure may mount the battery pack assembly 3 on the lower portion of the vehicle body 1 through a series of processes as described above.

According to the battery mounting system 100 according to the embodiment of the present disclosure as described so far, the one servo motor 111 and the pair of chain winding units 121 are provided as driving sources of the lifting unit 110.

Therefore, unlike the comparison example of using two servo motors in the related art, the battery mounting system 100 according to the embodiment of the present disclosure uses the one servo motor 111, thereby reducing the investment cost of facilities, and improving the control operability of facilities.

In addition, according to the battery mounting system 100 according to an embodiment of the present disclosure, as the safety cylinder 161 is employed, in case of failure of the at least one servo motor 111 and the chain winding unit 121, falling of the lift frame 141 may be prevented.

Furthermore, the battery mounting system 100 according to an embodiment of the present disclosure may absorb a position distribution of the vehicle body 1 through the floating unit 210 having a simple configuration, and may mount the battery pack assembly 3 exactly on the set position of the vehicle body 1.

Accordingly, the battery mounting system 100 according to the present disclosure may secure the mountability (e.g., degree of mounting) and robustness of mounting of the battery pack assembly 3 with respect to the vehicle body 1 and may minimize mounting failure of the battery pack assembly 3.

In addition, the battery mounting system 100 according to an embodiment of the present disclosure may rotate the shift plate 211 through the arc guide rail 233 of the floating unit 210, thereby implementing stable floating of the shift plate 211.

In addition, as the battery mounting system 100 according to an embodiment of the present disclosure includes the arc guide rail 233 instead of a bearing, according to an example of the related art, mechanical noise may be reduced while minimizing the flow or movement of the shift plate 211, and the maintainability of the parts may be improved.

Furthermore, in the battery mounting system 100 according to an embodiment of the present disclosure, as the at least one first clamper 510 and the at least one second clamper 610 clamping the shift plate 211 are configured in a roller type, malfunction minimizing mechanical noise caused by high load.

In addition, the battery mounting system 100 according to an embodiment of the present disclosure may adjust the position of the pair of nut runners 721a among the plurality of nut runners 721, thereby allowing the battery pack assembly 3 to be mounted on vehicle bodies 1 of various types with a single facility.

Although several embodiments of the present disclosure have been described above, the present disclosure is not limited thereto, and various modifications and implementations are possible within the scope of the claims, the description, and the accompanying drawings, and it is natural that this also falls within the scope of the present disclosure.

<Description of symbols>

| | |
|---|---|
| 1: vehicle body | 3: battery pack assembly |
| 3a: master hole | 5: vehicle body hanger |
| 7: skid cart | 8: tooling hole |
| 9: fastening member | 10: base frame |
| 100: battery mounting system | 110: lifting unit |
| 111: servo motor | 121: chain winding unit |
| 131: push-pull chain | 141: lift frame |
| 143: cross beam | 151: lift plate |
| 161: safety cylinder | 163: mounting frame |
| 165, 353, 363, 754, 756, 764, 766: | |
| operation rod | |
| 171: guide shaft | 210: floating unit |
| 211: shift plate | 231: first floating assembly |
| 233: arc guide rail | 235: first slider |
| 237: first floating plate | 251: second floating assembly |
| 253: first straight guide rail | 255: second slider |
| 257: second floating plate | 261: second straight guide rail |
| 263: third slider | 310: first centering unit |
| 311: mounting plate | 321: fixing block |
| 331: push guide rail | 341: moving block |
| 351: first push cylinder | 361: second push cylinder |
| 371: push block | 381: up-down cylinder |
| 391: guide plate | 410: second centering unit |
| 411: fixing bracket | 413: first vertical guide rail |
| 421: first moving bracket | 423: second vertical guide rail |
| 431: second moving bracket | 441: gripper cylinder |
| 443: horizontal guide rail | 451: pull-push gripper |
| 461: main vertical cylinder | 471: sub vertical cylinder |
| 481: horizontal cylinder | 510: first clamper |
| 511: first clamping cylinder | 531: first clamping roller |
| 533: first dog block | 610: second clamper |
| 611: second clamping cylinder | 631: second clamping roller |
| 633: second dog block | 710: tool assembly |
| 711: slide plate | 713: first rail block |
| 721, 721a: nut runner | 723: second rail block |
| 725: first operation cylinder | 727a, 727b: sliding block |
| 729a, 729b: third rail block | 731: master pin |
| 733: second operation cylinder | 741: mounting block |
| 751: first position adjusting unit | 753: first position adjusting |
| | cylinder |
| 755: second position adjusting cylinder | |
| 761: second position adjusting unit | |
| 763: third position adjusting cylinder | |
| 765: fourth position adjusting cylinder | |
| 810: driving wheel | 811: wheel driving motor |
| 820: idle wheel | 830: cart clamper |
| 840: tooling pin | 911: sensor |

What is claimed is:

1. A battery mounting system configured to mount a battery pack assembly loaded on a skid cart on a lower portion of a vehicle body, the battery mounting system comprising:
a lifting unit including a lift plate configured to move in an up and down direction, the lifting unit installed on a base frame;
a floating unit including a shift plate coupled to the skid cart, the floating unit installed on the lift plate so that the shift plate moves in accordance with a position of the vehicle body; and
a tool assembly installed on both sides of the shift plate in a vehicle width direction to fasten the vehicle body and the battery pack assembly.

2. The battery mounting system of claim 1, wherein the lifting unit includes:
a servo motor fixed to the base frame;
at least two chain winding units operatively connected to the servo motor, one of the at least two chain winding units provided on each side of the servo motor in a vehicle body front and rear direction;
at least two push-pull chains, one of the at least two push-pull chains respectively connected to each of the chain winding units so as to travel in the up and down direction; and
at least two lift frames, one of the at least two lift frames respectively coupled to each side of the lift plate in the vehicle body front and rear direction and connected to the at least two push-pull chains.

3. The battery mounting system of claim 2, wherein the lifting unit further includes:
at least two safety cylinders coupled to mounting frames that are coupled to the base frame in the up and down direction, one of the at least two safety cylinders respectively connected to each of the at least two lift frames; and
at least two guide shafts, one of the at least two guide shafts respectively mounted on each of the mounting frames to be movable in the up and down direction and respectively coupled to each side of the lift plate.

4. The battery mounting system of claim 1, wherein the floating unit includes:
a first floating assembly installed on the lift plate so as to rotate the shift plate, and
a second floating assembly installed on the first floating assembly so as to move the shift plate in the vehicle body front and rear direction and the vehicle width direction, the second floating assembly coupled to the shift plate.

5. The battery mounting system of claim 4, wherein the first floating assembly includes:
an arc guide rail coupled to both sides of an upper surface of the lift plate in the vehicle body front and rear direction;
at least one first slider slidably coupled to the arc guide rail; and
a first floating plate coupled to the at least one first slider in the vehicle width direction.

6. The battery mounting system of claim 5, wherein the second floating assembly includes:
at least one first straight guide rail coupled to an upper surface of the first floating plate in the vehicle width direction;
a second slider slidably coupled to the at least one first straight guide rail;
a second floating plate coupled to the second slider in the vehicle body front and rear direction;
a second straight guide rail coupled to an upper surface of the second floating plate in the vehicle body front and rear direction; and
a third slider slidably coupled to the second straight guide rail and coupled to a lower portion of the shift plate.

7. The battery mounting system of claim 1, further comprising:
at least two first centering units configured to push the vehicle body in the vehicle width direction, one of the at least two centering units installed on each side of the shift plate in the vehicle width direction so as to adjust centering of the shift plate through the floating unit; and
a second centering unit configured to pull and/or push the vehicle body in the vehicle body front and rear direction, the second centering unit installed on one side of the shift plate in the vehicle body front and rear direction so as to adjust centering of the shift plate through the floating unit.

8. The battery mounting system of claim 7, wherein the first centering unit includes:
at least two mounting plates, one of the at least two mounting plates respectively fixed to each side of a lower portion of the shift plate in the vehicle width direction;
at least one fixing block coupled to the each of the at least two mounting plates in the vehicle width direction;
a push guide rail coupled to the at least one fixing block in the vehicle width direction;
a moving block coupled to the push guide rail to be slidably movable;
a first push cylinder coupled to the at least one fixing block in the vehicle width direction;
a second push cylinder connected to the moving block in the vehicle width direction and connected to the first push cylinder in the vehicle width direction; and
a push block installed on the moving block to be movable in the up and down direction.

9. The battery mounting system of claim 8, wherein the first centering unit further includes:
a guide plate coupled to the moving block so as to support a lower portion of the second push cylinder; and
an up-down cylinder coupled to the moving block in the up and down direction and connected to the push block.

10. The battery mounting system of claim 7, wherein the second centering unit includes:
a gripper cylinder installed on the shift plate to be movable in the vehicle body front and rear direction and the up and down direction; and
a pair of pull-push grippers installed on the gripper cylinder to be movable in a direction away from or closer to each other.

11. The battery mounting system of claim 10, wherein the second centering unit includes:
a fixed bracket fixed to the shift plate;
a first moving bracket coupled to the fixed bracket to be movable in the up and down direction;
a second moving bracket coupled to the first moving bracket to be movable in the up and down direction, and to which the gripper cylinder is coupled to be movable in the vehicle body front and rear direction;
a main vertical cylinder coupled to the fixing bracket in the up and down direction and connected to the first moving bracket;
a sub vertical cylinder coupled to the first moving bracket in the up and down direction and connected to the second moving bracket; and
a horizontal cylinder coupled to the second moving bracket in the vehicle body front and rear direction and connected to the gripper cylinder.

12. The battery mounting system of claim 1, further comprising:
at least one first clamper installed on an upper surface of the lift plate so as to clamp the shift plate in the vehicle body front and rear direction; and
at least one second clamper installed on the upper surface of the lift plate so as to clamp the shift plate in the vehicle width direction.

13. The battery mounting system of claim 12, wherein the at least one first clamper includes:
a first clamping cylinder coupled to the upper surface of the lift plate in the vehicle body front and rear direction; and
a pair of first clamping rollers connected to the first clamping cylinder so as to clamp a first dog block connected to the shift plate.

14. The battery mounting system of claim 13, wherein the at least one second clamper includes:
a second clamping cylinder coupled to the upper surface of the lift plate in the vehicle width direction; and
a pair of second clamping rollers connected to the second clamping cylinder so as to clamp a second dog block connected to the shift plate.

15. The battery mounting system of claim 1, wherein the tool assembly includes:
at least two slide plates, one of the at least two slide plates respectively coupled to each side of the shift plate in the vehicle width direction to be slidably movable in the vehicle width direction;
a plurality of nut runners installed on the at least two slide plates in the vehicle body front and rear direction and provided to be movable in the up and down direction; and
at least one master pin installed on the at least two slide plates to be movable in the up and down direction so as to be inserted into a master hole formed in the battery pack assembly in the up and down direction.

16. The battery mounting system of claim 15, wherein a pair of nut runners among the plurality of nut runners are respectively coupled to the at least two slide plates to be movable in the vehicle body front and rear direction.

17. The battery mounting system of claim 16, wherein the tool assembly includes:
at least one mounting block fixed to each of at least two mounting plate, one of the at least two mounting plates respectively coupled to each side of a lower portion of the shift plate in the vehicle width direction;
a first position adjusting unit installed on the at least one mounting block so as to adjust positions of the at least two slide plates in the vehicle width direction; and
a second position adjusting unit installed on the at least two slide plates so as to adjust positions of the pair of nut runners in the vehicle body front and rear direction.

18. The battery mounting system of claim 17, wherein the first position adjusting unit includes:
a first position adjusting cylinder coupled to the at least one mounting block in the vehicle width direction; and
a second position adjusting cylinder connected to the first position adjusting cylinder in the vehicle width direction and connected to the at least two slide plates in the vehicle width direction.

19. The battery mounting system of claim 17, wherein the second position adjusting unit includes:
a third position adjusting cylinder coupled to the at least two slide plates in the vehicle body front and rear direction and connected to one of the pair of nut runners; and
a fourth position adjusting cylinder coupled to the at least two slide plates in the vehicle body front and rear direction and connected to the other of the pair of nut runners.

20. The battery mounting system of claim 1, further comprising:
a plurality of driving wheels and a plurality of idle wheels installed on both edges of the shift plate in the vehicle body front and rear direction so as to move the skid cart in the vehicle body front and rear direction;
at least one cart clamper installed on the shift plate so as to clamp the skid cart; and
at least one tooling pin installed on the shift plate to be movable in the up and down direction so as to align the skid cart on the shift plate.
